(19) United States
(12) Patent Application Publication
(10) Pub. No.: US 2014/0003282 A1
(43) Pub. Date: Jan. 2, 2014

(54) Network Discovery and Mobility Management for White Space Devices

(71) Applicants: Padam Lal Kafle, Coppell, TX (US); Mika Ilkka Tapani Kasslin, Espoo (FI); Prabodh Varshney, Coppell, TX (US)

(72) Inventors: Padam Lal Kafle, Coppell, TX (US); Mika Ilkka Tapani Kasslin, Espoo (FI); Prabodh Varshney, Coppell, TX (US)

(73) Assignee: NOKIA CORPORATION, Espoo (FI)

(21) Appl. No.: 13/534,606

(22) Filed: Jun. 27, 2012

(51) Int. Cl. H04W 48/16

(52) U.S. Cl. 370/254

(57) ABSTRACT

A mobile device may transmit a request communication to one or more candidate wireless network access points and receive a response from a responding access point. Based on the received response communication, the mobile device may exchange further communications with the responding access point. At least one of the request communication or the response communication may include data corresponding to at least one of a location-dependent communication parameter database or a provider of a location-dependent communication parameter database.

### BACKGROUND

Unused frequencies in the TV band spectrum are known as TV white spaces (TVWS). Various regulators have recently considered efforts to allow unlicensed use of white spaces in TV broadcast bands. As one example, the United States Federal Communications Commission (FCC) released final rules for unlicensed operation in the TV broadcast bands on Sep. 23, 2010. As another example, the United Kingdom Office of Communications (“Ofcom”) has ongoing initiatives in this field. New and/or pending regulations by these authorities permit (or are going to permit) unlicensed wireless devices to operate in a new region of the VHF and UHF spectrum band (e.g., 54 MHz-698 MHz in the U.S.). Such devices will operate on an opportunistic sharing basis using TV channel frequencies not occupied by a licensed primary user of the relevant spectrum band. Such primary users include licensed TV broadcasters and wireless microphone systems.

An unlicensed device that operates in the TVWS may be referred to as a white space device (WSD). A geo-location database (GDB) may be used to enforce TVWS regulatory requirements and protect the primary services in the TV band. Depending on whether a licensed user in a particular location is utilizing a particular part of the TVWS spectrum, TVWS channels and other communication parameters available for unlicensed devices may vary on a location-to-location basis. In response to queries, the GDB provides these location-dependent communication parameters for elements in WSD networks.

Wireless LAN (WLAN) or “Wi-Fi” is a technology suitable for use of TVWS spectrum. Apart from providing additional spectrum space to WLAN devices, better propagation characteristics at the VHF or lower UHF band offer longer range than that is typically possible for WLAN systems in 2.4 or 5 GHz band.

In both the FCC and Ofcom schemes, as well as in other scenarios, one station (STA) providing WLAN (or other wireless network) access to another STA is known as “enablement.” A STA can be a device of any of various types. “Enabling communications” include communications between a WSD and a GDB, and/or between the WSD and other devices(s) that may be communicating with the GDB, to exchange TVWS communication parameters or other enablement-related data. An enabling STA provides an enabled STA with access to a WLAN. In some scenarios, the functionalities of enabling STAs and dependent STAs may be mapped to the FCC model. In some such scenarios, an enabling STA might further be required to have geo-location capability and be able to communicate with an authorized GDB to initiate a WLAN network. These scenarios might further assume that all dependent STAs are incapable of communicating directly with the GDB, but are instead allowed to operate when enabled by an enabling STA.

Enablement and subsequent control during operation of dependent STAs may involve three separate processes: (a) a geo-location database control (GDC) enablement process, (b) a channel availability query (CAQ) process and (c) a contact verification signal (CVS) process. In the GDC enablement process, a dependent STA (e.g., a Mode I personal/portable device in the FCC regulatory scheme) can send its device identification information (i.e., an FCC ID) to an enabling STA for verification and receive a list of channels available for use by the dependent STA. A CAQ procedure allows a dependent STA to acquire an available channel list during operation in order to maintain the validity of an enablement timer. The CAQ process may be initiated by an enabling STA to obtain a list of permissible channels and associated parameters from an RLSS (registered location secure server) entity that may serve multiple enabling STAs. The CVS process requires that a dependent STA, in order to continue using a channel and other enablement parameters authorized by an enabling STA, receive a unicast contact verification signal (CVS) frame at least every 60 seconds to ensure it is within the coverage area of that enabling STA.

There are some differences between operation of dependent STAs under the FCC regulatory scheme and operation of dependent STAs in the Ofcom regulatory scheme. For example, the FCC scheme assumes that a Mode I personal/portable device is not able to provide geo-location information. Under the Ofcom scheme, some dependent STAs, also known as slave devices, may be able to provide such information. The Ofcom database model assumes that an enabling STA (also known as a master device) is required to make a database query on behalf of a slave device with relevant information about the slave device, and to then pass on the parameters obtained from the database, e.g., available channel and other communication parameters including permitted power and time validity.

Due to superior propagation characteristics in the UHF band, as well as the possibility for some WSDs to operate at higher powers, Wi-Fi networks in TVWS band are likely to have larger coverage areas compared to legacy Wi-Fi bands. This new available spectrum can increase the deployment of Wi-Fi networks to outdoor areas such as city centers, parking lots, etc., and/or expand indoor usage with fewer access points in large malls, entertainment centers, etc. With such deployment scenarios, mobility of the WSDs may also become more important. The FCC and Ofcom models assume the possibility of mobility by WSDs in the TVWS band, especially the personal/portable device category in the FCC scheme and personal/mobile WSDs in the Ofcom scheme. It would be useful for WSDs and related systems to include mechanisms to support discovery of other networks suitable for handover or roaming. It would also be useful for an access point (AP, another term for a master device) and/or other systems to include improved mechanisms for managing mobility of a slave device that has geo-location capability.

### SUMMARY

This Summary is provided to introduce a selection of concepts in a simplified form that are further described below in the Detailed Description. This Summary is not intended to identify key or essential features of the invention.

Embodiments include, without limitation, methods for discovery of and/or providing information regarding candidate access points, methods for receiving and/or transmitting a contact verification signal, and methods for managing queries of a location-dependent communication parameter database. Embodiments further include, without limitation, devices and/or systems configured to perform such methods. Embodiments additionally include, without limitation, machine-readable media storing instructions that, when executed, cause a device and/or system to perform such methods.

In at least some embodiments, a mobile device may transmit a request communication to one or more candidate wireless network access points and receive a response from a responding access point. Based on the received response communication, the mobile device may exchange further communications with the responding access point. At least one of the request communication or the response communication may include data corresponding to at least one of a location-dependent communication parameter database or a provider of a location-dependent communication parameter database.

In at least some embodiments, a mobile device transmits a request for at least one of transmission of a verification signal and transmission of future verification signals using a specified maximum time between verification signals. In response to the request, a receiving device may transmit an immediate verification signal and/or may transmit future verification signals using the specified maximum time between verification signals.

In at least some embodiments, an access point or other device may predict one or more possible future locations of a mobile device. The access point or other device may then query a location-dependent communication parameter database for communication parameters associated with the one or more possible future locations. In response to the query, the access point or other device may receive and store data comprising the communication parameters associated with the one or more possible future locations. The stored data may then be used when responding to requests for communication parameters based on a changed location of the mobile device.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 is a diagram showing elements in several wireless networks according to at least some embodiments.

FIG. 2 is a diagram showing data carried by a modified probe request frame according to at least some embodiments.

FIG. 3 is a diagram showing data carried by a modified probe response frame according to at least some embodiments.

FIG. 4 shows additional details of an AP response parameter element according to some embodiments.

FIGS. 5A and 5B show communications between, and operations performed by, a scanning WSD and scanned APs according to some embodiments.

FIG. 6 is a diagram showing data carried by a CVS request frame according to at least some embodiments.

FIG. 7 is a diagram showing data carried by a modified CVS frame according to at least some embodiments.

FIG. 8 is a diagram showing CVS communications between a mobile WSD and an AP according to at least some embodiments.

FIG. 9 is a diagram showing mobility management communications and operations according to at least some embodiments.

FIG. 10 is a block diagram of a computer according to at least some embodiments.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

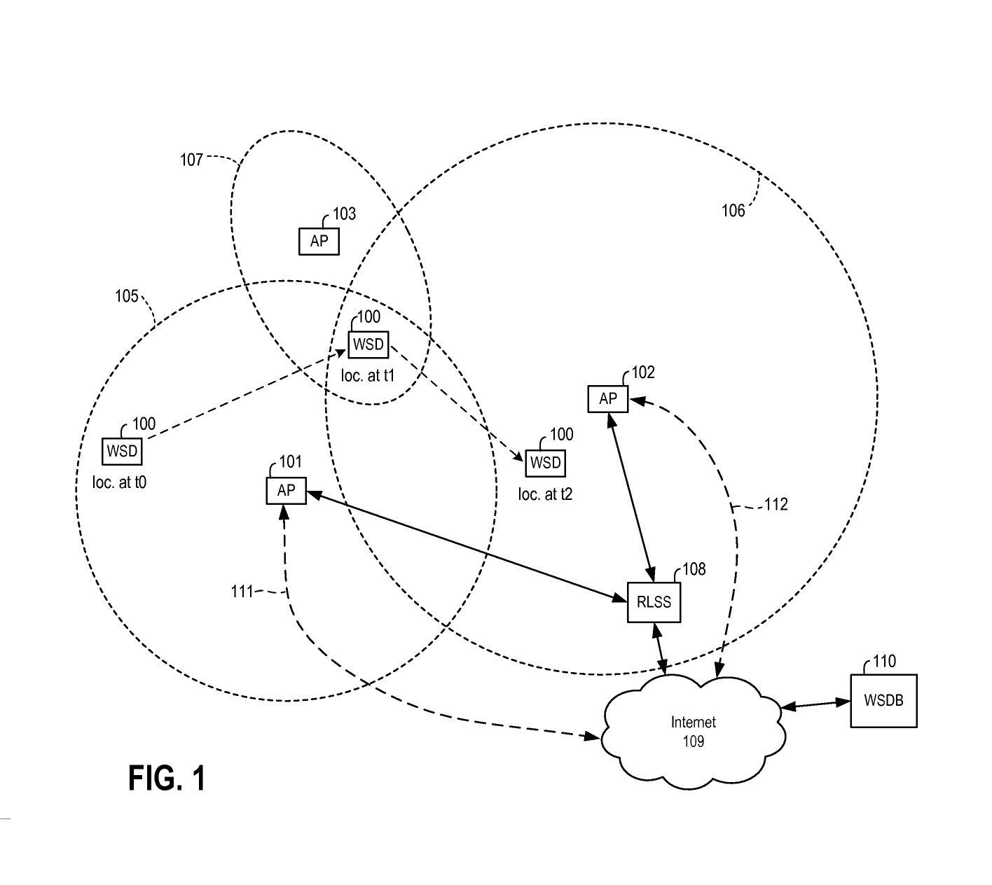

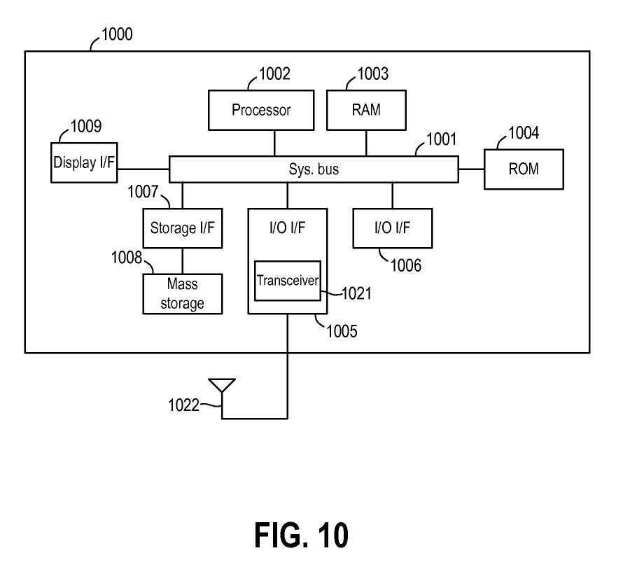

FIG. 1 is a diagram showing elements in several wireless networks according to some embodiments. A mobile white space device (WSD) 100 is a slave WSD, also known as an enabled WSD, dependent WSD, slave STA, enabled STA or dependent STA. Mobile WSD 100 is able to communicate in portions of the radio spectrum corresponding to TV white spaces (TVWS). Mobile WSD 100 may also have geo-location capabilities. For example, WSD 100 may include a GPS (global positioning system) receiver and hardware and/or software configured to calculate a position based on GPS satellite signals. Additional features of, and operations performed by, WSD 100 are described below. Exemplary hardware for WSD 100 is described in connection with FIG. 10.

Also shown in FIG. 1 are three access points (APs) 101, 102 and 103. Each of APs 101, 102 and 103 is a master WSD, also known as an enabling WSD, a master STA or an enabling STA. AP 101 has a first coverage area 105 throughout which AP 101 communicates with one or more mobile WSDs located in coverage area 105. AP 101 may be, e.g., a high power outdoor AP. Additional features of, and operations performed by, AP 101 are described below. Exemplary hardware for AP 101 is described in connection with FIG. 10.

AP 101 may communicate with a registered location secure server (RLSS) 108. RLSS 108 may be a computer or collection of computers. RLSS may be co-located with AP 101, co-located with another AP served by RLSS 108, or located elsewhere. Although a direct connection between AP 101 and RLSS 108 is shown for convenience, AP 101 could alternately communicate with RLSS 108 via the Internet 109 and/or another network or combination of networks. Additional features of, and operations performed by, RLSS 108 are described below. Exemplary hardware for RLSS 108 is described in connection with FIG. 10.

RLSS 108 communicates with a white space database (WSDB) 110. WSDB 110 may also be a computer or collection of computers. In the example of FIG. 1, WSDB 110 is remotely located from RLSS 108 and other APs (e.g., AP 102 discussed below) served by WSDB 110 and communicates with RLSS 108 via the Internet 109. WSDB 110 could alternately be co-located with RLSS 108 and/or an AP served by WSDB 110 and/or implemented in the same computer or system of computers implementing RLSS 108. WSDB 110 might also communicate with RLSS 108 via one or more other types of network configurations that may or may not include Internet 109. Additional features of, and operations performed by, WSDB 110 are described below. Exemplary hardware for WSDB 110 is described in connection with FIG. 10.

An RLSS may be absent in some embodiments. In some such embodiments, APs may communicate directly with a WSDB such as WSDB 110. This is indicated by broken lines 111 and 112 in FIG. 1. In other embodiments, an RLSS may be present, but some APs may communicate with the RLSS and other APs may communicate directly with the WSDB. In still other embodiments, one or more APs may communicate with an RLSS for some purposes and communicate directly with a WSDB for other purposes.

FIG. 1 further shows two additional APs 102 and 103. AP 102 has a second coverage area 106 throughout which AP 102 communicates with one or more mobile WSDs located in coverage area 106. AP 102 may be, e.g., another high power outdoor AP or may be a high power indoor AP. AP 102 also communicates with, and is served by, RLSS 108 and WSDB 110. AP 103 has a third coverage area 107 throughout which AP 103 communicates with one or more mobile WSDs located in coverage area 107. AP 103 is served by an RLSS (not shown) other than RLSS 108 and a WSDB (also not shown) other than WSDB 110. Additional features of, and operations performed by, APs 102 and 103 are described below. Exemplary hardware for APs 102 and 103 is described in connection with FIG. 10.

As indicated in FIG. 1, mobile WSD 100 is served by AP 101 at time t0 and is in the WLAN and basic service set (BSS) of AP 101. At time t1, WSD 100 is in a location within coverage areas 105, 106 and 107. At time t2, WSD 100 is in coverage area 106. When mobile WSD 100 is about to roam outside of coverage area 105, it would be useful if mobile WSD 100 could discover another WLAN/BSS in which an AP of that other WLAN/BSS is served by the same database service provider (e.g., WSDB 110) that serves AP 101. For example, this could permit mobile WSD 100 to continue using one or more value-added services associated with that database service provider. As another example, this could permit mobile WSD 100 to continue operations using security credentials already established through AP 101. It would also be useful if mobile WSD 100 could discover capabilities of a candidate AP into whose WLAN/BSS WSD 100 may potentially roam and by whom mobile WSD may potentially be enabled. This could permit mobile WSD 100 to determine it a candidate AP can currently provide enablement to WSD 100 (e.g., if there are sufficient available channels), as well as whether the candidate AP can satisfy one or more criteria of WSD for a new AP.

At least some embodiments include procedures by which mobile WSD 100 can discover information regarding a candidate AP. In addition to the potential advantages noted above, these procedures may allow faster discovery of an AP and performance of a fast BSS transition (FT), e.g., in accordance with IEEE standard 802.11r (now part of IEEE standard 802.11-2012). For example, these procedures may allow mobile WSD 100 to determine faster trigger conditions necessary to initiate FT in the TVWS band.

In at least some embodiments, these procedures modify an active scanning procedure so that mobile WSD 100 can identify an AP with desired capabilities. For example, a scanning WSD such as mobile WSD 100 can determine if a scanned AP is a master WSD and whether it can currently enable additional slave WSDs. The scanning WSD may also determine how the scanned AP handles database control tasks associated with an applicable regulatory scheme, which in turn may require information about a GDB service provider. The scanning WSD may further determine parameters associated with enablement by the scanned AP.

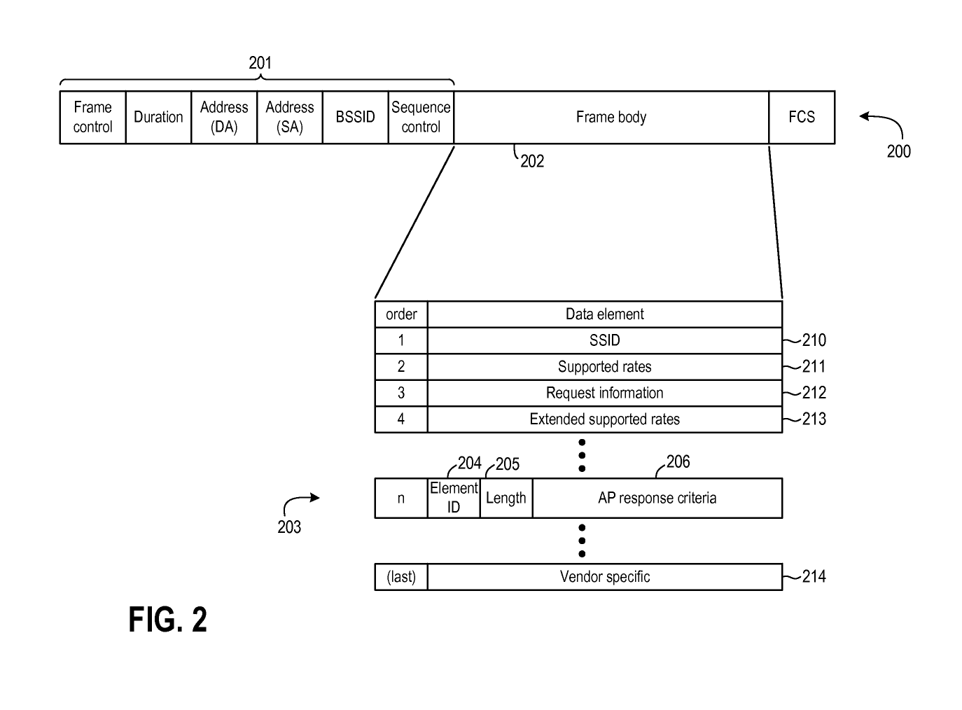

In at least some such embodiments, an active scanning procedure adds criteria for a candidate AP and solicits a response. In some such embodiments, these criteria can be included in a probe request frame, and a scanning device is a device transmitting such probe requests. A scanned device may be a device that receives probe requests. A scanned AP receiving a probe request may respond by transmitting a probe response frame. The general concept of probe frames is described in IEEE 802.11-2012 and/or other IEEE standards. Embodiments include probe request and probe response frames that are modified to include information as described herein. For example, FIG. 2 is a diagram showing data carried by a modified probe request frame 200 according to some such embodiments.

Frame 200 may include a MAC (media access control) header 201. MAC header 201 may be a conventional 802.11 MAC header, and may include a two byte frame control field (used to carry data regarding applicable protocol and version, frame type, etc.) and a two byte duration field (used to carry data used for updating a network allocation vector). MAC header 201 may further include a six byte field for destination address (DA). This DA may be a multicast DA or broadcast DA for scanned APs. In some embodiments, a probe request might be addressed to a specific AP, and the DA might thus be the address of a specific AP. A WSD sending a probe request to a specific AP might obtain the DA for that AP from, e.g., a beacon communication broadcast from that AP. MAC header 201 also includes a six byte field for a source address (SA) (e.g., an SA of the scanning mobile WSD sending the probe request), a six byte field for a BSS identifier (BSSID) (e.g., the BSSID of the scanned AP or a wildcard BSSID) and a 2 byte sequence control field (used, e.g., to indicate the sequence of separate fragments belonging to the same frame). Frame 200 may further include a frame body 202, of between zero and 2312 bytes, as well as a four byte frame check sequence (FCS).

Frame body 202 may contain a data element 203 that includes data specifying candidate AP response criteria, i.e., criteria of the scanning WSD for an AP from which the scanning WSD will seek enablement. Element 203 may include a first field 204 that contains an identifier indicating the element is a type of element that will seek a response from APs based on response criteria contained within the element. Element 203 may contain a second field 205 that indicates the size of element 203. Element 203 may then contain a third field (or collection of fields) 206 that indicate the AP response criteria.

Data element 203 may follow data elements 210 through 213 and precede data element 214. Data elements 210 through 213 may be standard fixed or variable size data elements similar to data elements defined by IEEE 802.11-12 and/or other IEEE standards. For example, data element 210 may indicate a service set identifier (SSID), e.g., a wildcard value, a value corresponding to a BSS or ESS (extended service set), etc. Data element 211 may indicate data rates supported by the scanning WSD. Data element 212 may be used to indicate that an AP responding to the probe request should include requested information in a probe response frame; probe response frames are described below. Data element 213 may be used to indicate additional supported data rates (e.g., if there are more data rates than can be conveyed in the fixed size of element 211), and may be dependent on the type of physical layer being used. Data element 214 may be reserved for use by vendor-specific software of a mobile WSD or of an AP. Additional and/or other data elements may precede and/or follow data element 203. Data elements 210-214 are merely included in FIG. 2 as examples of the types of data elements that might be included with data element 203 in frame body 202. The “n” indicating the order of data element 203 relative to other data elements indicates an arbitrary location between data elements 213 and 214.

Focusing on data element 203, AP response criteria in field 206 may include a device type of a responding device (e.g., of a responding AP). For example, a mobile master WSD in a new WLAN may be configured to act as an AP. As another example, a slave WSD in a new WLAN may be operating as an AP or may otherwise potentially respond to a probe request. A scanning WSD may only be seeking to associate with a fixed master WSD, may not be seeking to associate with a slave device currently operating as an AP, etc.

The AP response criteria may further include an identifier for one or more providers of location-dependent communication parameter databases (e.g., GDB service providers). Such an identifier might alternatively or also include an identifier of a specific location-dependent communication parameter database, e.g., a WSDB such as WSDB 110. The scanning WSD may be seeking to associate with an AP that is connected to (or otherwise in communication with or served by) a preferred GDB service provider or by a GDB service provider selected from a group of preferred GDB service providers. Thus, the AP response criteria may include identifier(s) of the preferred GDB service provider(s). Each GDB service provider may have a unique identifier (e.g., as established by applicable regulations) such as an IP (internet protocol) address or otherwise represented by a unique string, integer or other representation.

The AP response criteria may additionally include a mobility domain ID for a particular mobility domain (e.g., a collection of AP controllers that have been configured with each other's MAC and IP addresses, e.g., within an ESS). The scanning WSD may be seeking to associate with an AP that is part of a specific mobility domain, e.g., the mobility domain that includes an AP with which the scanning WSD is currently associated. Thus, the AP response criteria may include an identifier of that mobility domain.

The AP response criteria may also include channel- and/or frequency-related criteria. For example, the scanning WSD may be seeking to associate with an AP having certain available frequency ranges and/or channels, and/or that permits a certain minimum transmit power level in those frequency ranges and/or channels. Thus, the AP response criteria may include a list of one or more frequency ranges and/or channels and/or specified minimum transmit power levels in those channels or frequency ranges. In some cases, for example, a scanning WSD may be currently using a particular channel and transmitting at a particular power level. The scanning WSD may wish to continue use of that channel and transmitting at that power level when in a new BSS. For instance, the scanning WSD may be part of an ongoing peer-to-peer link with other WSDs using TDLS (tunneled direct link setup) or as part of an IBSS (independent basic service set), which link may require use of a particular channel and may require the scanning WSD to transmit at a certain power level.

AP response criteria field 206 may additionally include spectrum mask information of the scanning WSD. Some APs may not allow slave WSDs having certain spectrum mask characteristics. Accordingly, the scanning WSD may provide its spectrum mask information as part of the AP response criteria so as to indicate what type of slave WSD transceiver spectral properties must be allowed in a WLAN/BSS that the scanning WSD seeks to join.

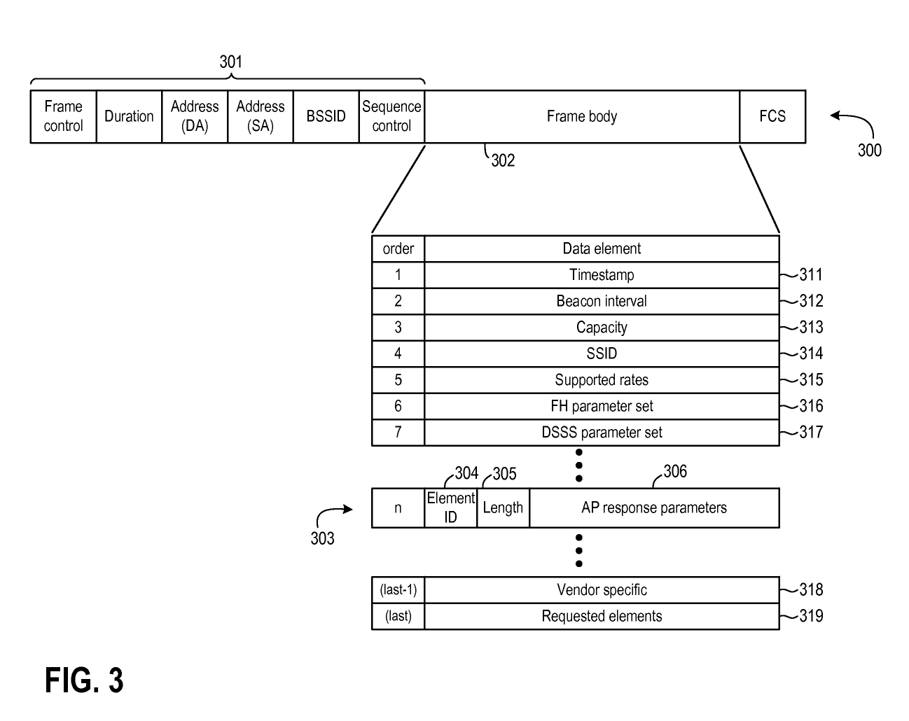

FIG. 3 is a diagram showing data carried by a modified probe response frame 300 according to some embodiments. An AP receiving a probe request frame such as frame 200 could respond by transmitting a probe response frame such as frame 300. In some embodiments, an AP may only transmit a probe response if the AP is able to meet all of the AP response criteria contained in field 206 of a received probe request. In other embodiments, an AP may transmit a probe response even if it cannot satisfy all of the AP criteria in a received probe request.

Probe response frame 300 may include a MAC header 301. MAC header 301 may also be a conventional 802.11 MAC header, and may include a two byte frame control field, a two byte duration field, a six byte field for destination address (DA) (e.g., a DA for the scanning WSD to which a probe response is addressed), a six byte field for a source address (SA) (e.g., an SA of the scanned AP sending the probe request), a six byte field for a BSS identifier (BSSID) (e.g., the BSSID of the BSS of which the scanned AP is currently a member) and a 2 byte sequence control field. Frame 300 may further include a frame body 302, of between zero and 2312 bytes, as well as a four byte frame check sequence (FCS).

Frame body field 302 may contain a data element 303 that indicates response parameters provided by the scanned AP in response to the received probe request. Element 303 may include a first field 304 that contains an identifier indicating the element is the type of element that will contain candidate AP response parameters. Element 303 may contain a second field 305 that indicates the size of element 303. Element 303 may then contain a third field (or collection of fields) 306 that indicate the AP response parameters.

Data element 303 may follow data elements 311 through 317 and precede data elements 318 and 319. Data elements 311 through 317 may be standard fixed or variable size data elements similar to data elements defined by IEEE 802.11-12 and/or other IEEE standards. For example, data element 311 may include a current time value at the scanned AP and may be used, e.g., to adjust a clock of a slave WSD. Data element 312 may include a time period between beacon transmissions by the scanned AP (e.g., transmissions with data about the AP that other devices can use when generating a probe request to send to that AP). A capacity element 313 may include data indicating the current capacity of the scanned AP. Data element 314 may include a service set identifier (SSID) of the responding AP. Data element 315 may indicate data rates supported by the scanned AP. Data element 316 may be used to include data needed to join a frequency-hopping WLAN. Data element 317 may be used to include data indicating direct-sequence spread spectrum parameters. Data element 318 may be reserved for use by vendor-specific software of a mobile WSD or of an AP. Data element 319 may contain information elements requested by the WSD sending a probe request to which the probe response is replying. Additional and/or other data elements may precede and/or follow data element 303. Data elements 311-319 are merely included in FIG. 3 as examples of the types of data elements that might be included with data element 303 in frame body 302. The “n” indicating the order of data element 303 relative to other data elements indicates an arbitrary location between data elements 317 and 318.

Focusing on data element 303, AP response parameters in field 306 of data element 303 may include data indicating the scanned AP can provide enablement to additional WSDs. In some embodiments, the capability of an AP to enable additional WSDs contemplates an ability of the AP to query a database for validation of a device identifier (e.g., an FCC ID) associated with the scanning WSD and/or to obtain permitted communication parameters of the scanning WSD. Such a database could be included as part of an RLSS such as RLSS 108. In some embodiments, and depending on the content of a received probe request (e.g., if the AP response criteria mandate an immediate willingness to enable an additional WSD), a scanned AP may include data indicating the scanned AP cannot immediately enable a new WSD, but further indicating that such AP is an enabling STA and enablement may be available at a future time. A scanned AP might also send a probe response that includes data indicating the AP cannot currently enable new WSDs if the received probe request did not specify an immediate ability for enablement as an AP response criteria.

AP response parameters may also include information about one or more providers of a location-dependent communication parameter database. Such a provider could be a GDB service provider with which the scanned AP is connected or otherwise able to communicate. This information could include, e.g., a list of specific location dependent communication parameter databases (e.g., WSDBs such as WSDB 110).

AP response parameters might further include data regarding the spectrum masks or other emission mask categories allowed or otherwise supported by the scanned AP in the BSS of the AP. The AP response parameters may include this information for various reasons. As one example, a scanned AP may send a probe response based on a probe request that did not include a spectrum mask of the scanning WSD. As another example, certain scanning WSDs may be able to operate under multiple transmission configurations that have differing spectrum masks. Such a WSD may be able to modify its transmission profile to exploit a tradeoff between EIRP (equivalent isotropically radiated power) vs. internal power consumption. Such a WSD might receive a probe response indicating a spectrum mask different than a spectrum mask included in a probe request previously sent by the WSD and elect to modify its transmission profile to satisfy the spectral requirements supported by the scanned AP.

AP response parameters may additionally include information that indicates a station type of the scanned AP. Possible station type data can include data indicating whether the scanned AP is an indoor or outdoor station, whether the scanned AP is a fixed or mobile station, whether the AP is a slave WSD or a master WSD, etc. AP response parameters may include station type data if, e.g., a received probe request did not indicate that only certain types of stations should respond to the probe request.

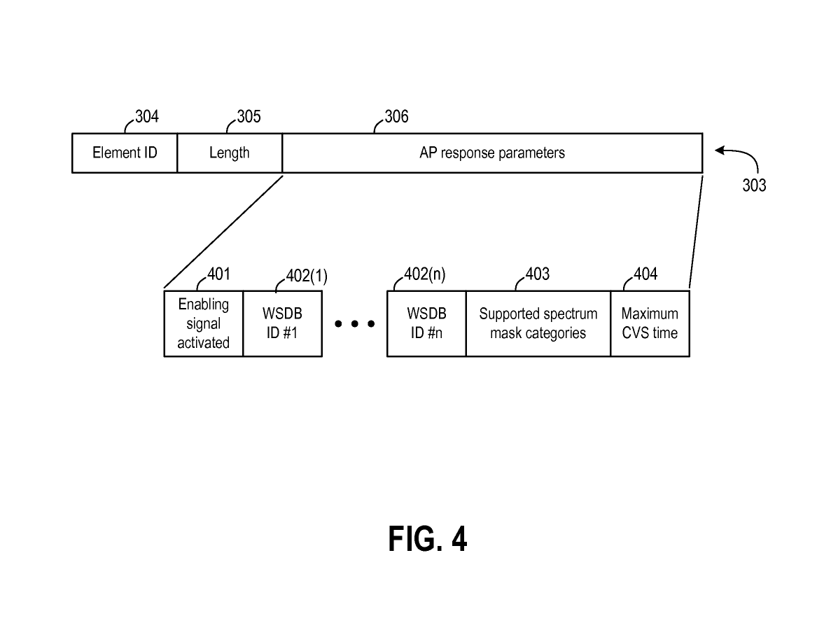

FIG. 4 shows additional details of element 303 according to some embodiments. Field 306 may be divided into additional fields that include an enabling signal activated field 401. This field could contain a flag having a value indicating whether the scanned AP will currently enable an additional WSD. Field 401 might also contain data indicating that the scanned AP will enable additional WSDs at a future time (e.g., if additional WSDs cannot currently be enabled), indicating the total number of additional WSDs that can be accommodated, etc. Each of fields 402(1) through 402(n) could contain an identifiers for a WSDB with which the scanned AP can communicate. In FIG. 4, “n” indicates that an arbitrary number of WSDB IDs could be included. In some embodiments, only one field 402 (with an ID for a single WSDB) may be present. Field 403 could contain data regarding supported spectrum mask categories for WSDs in the BSS of the scanned AP. Field 404 could contain a field indicating the maximum time between contact verification signals (CVSs) in the BSS of the scanned AP. Additional aspects of variable CVS timing are described below. Fields other than those shown in FIG. 4 could also or alternatively be included in field 306.

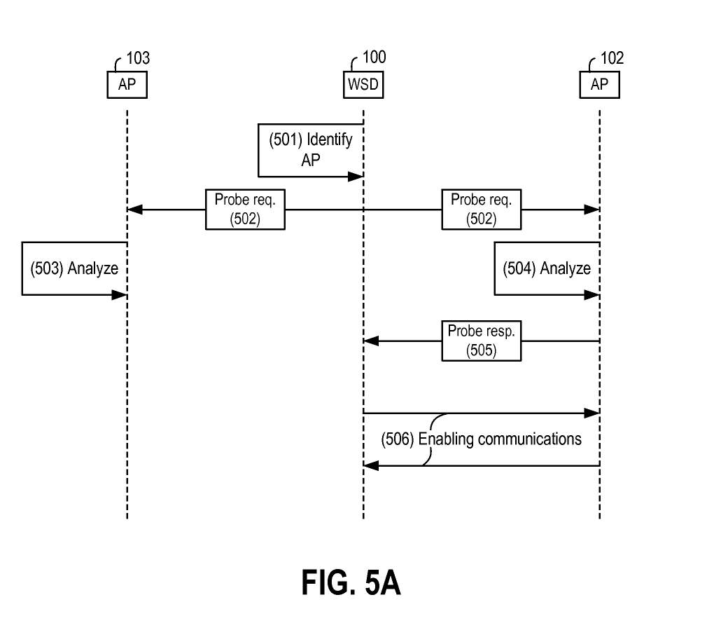

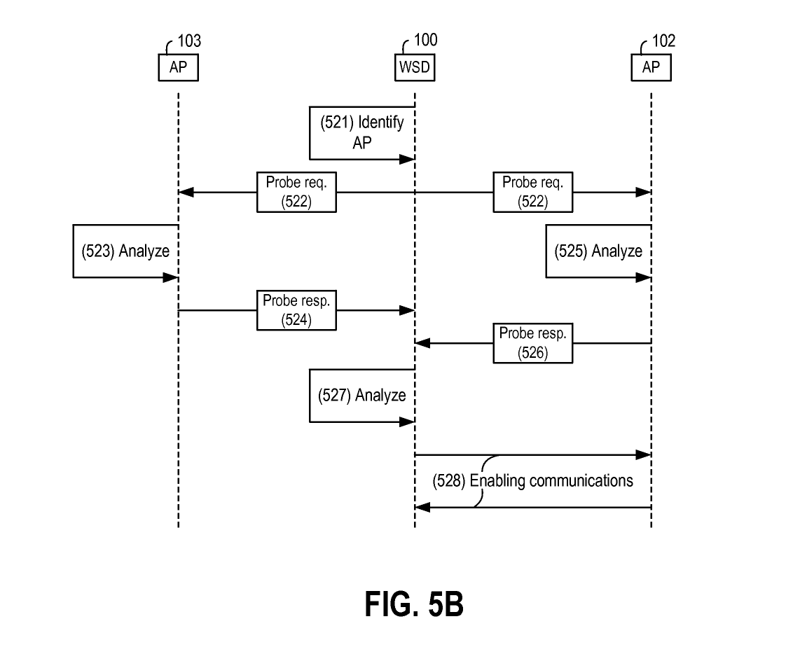

FIG. 5A is a diagram showing operations of, and communications between, mobile WSD 100 and APs 102 and 103 of FIG. 1, according to at least some embodiments, when mobile WSD has reached a new location at time t1. As shown in FIG. 5A by operations 501, mobile WSD 100 determines that it must identify a new AP from which can receive enablement. Mobile WSD 100 may make this determination in any of various ways. For example, WSD 100 may determine that a signal strength of communications from AP 101 has decreased below a threshold level, and/or that signal strengths of other APs (including AP 102 and/or AP 103) exceed the signal strength of AP 101 by a designated amount. As another example, mobile WSD may use its geo-location capabilities to determine that it has reached a location where a new AP should be identified.

Next, mobile WSD 100 sends a probe request 502. Probe request 502 may be in the form of frame 200 (FIG. 2) and may include AP response criteria and other information as described above in connection with frame 200. Probe request 502 is received by AP 103 and by AP 102. AP 103 analyzes probe request 502 and extracts the AP response criteria contained therein (operations 503). AP 103 then determines that it does not satisfy those extracted AP response criteria. For example, the AP response criteria may have specified that an AP be connected to (or otherwise in communication with or served by) WSDB 110. As a result of determining that it does not satisfy all of the AP response criteria contained in probe request 502, AP 103 does not send a probe response to probe request 502.

Probe request 502 is also analyzed by AP 102 (operations 504). As part of that analysis, AP 102 extracts the AP response criteria in probe request 502 and determines that AP 102 can satisfy all of those criteria. As a result of determining that it can satisfy all of the AP response criteria contained in probe request 502, AP 102 generates and sends a probe response 505 to WSD 100 in response to probe request 502. Probe response 505 may be in the form of frame 300 (FIG. 3) and may include AP response parameters and other information as described above in connection with frame 300 and data element 303 (FIGS. 3 and 4).

Subsequently, and as indicated by communications 506, mobile WSD 100 and AP 102 exchange further communications so that mobile WSD 100 is enabled by AP 102 and able to communicate with the WLAN of AP 102 and/or with additional networks (e.g., Internet 109) via the WLAN of AP 102. Communications 506 may be communications as described in U.S. patent application Ser. No. 13/468,989, filed May 10, 2012, and titled “Method, Apparatus, and Computer Program Product for Enablement,” which application in its entirety is incorporated by reference herein. Other types of communications for enabling WSD 100 by AP 102 and allowing WSD 100 to communicate in one or more networks via AP 102 (e.g., as described in IEEE standard 802.11-12 and/or other IEEE standards) could also be employed.

Between receipt of probe response 505 and commencement of communications 506, mobile WSD may also have received probe responses (not shown) from other APs not shown in FIG. 1. Mobile WSD 100 may have evaluated the AP response parameters contained in each received probe response and selected AP 102 based on one or more selection rules. As but one example, WSD 100 may be configured to select the AP having the largest range of available channels and/or having the strongest signal. In some embodiments, WSD 100 might be configured to select the first AP that sends a probe response indicating all AP response criteria are satisfied.

FIG. 5B is a diagram showing operations of, and communications between, mobile WSD 100 and APs 102 and 103 according to some additional embodiments. As shown in FIG. 5B by operations 521, mobile WSD 100 determines that it must identify a new AP from which it can receive enablement. The determinations of operations 521 may be the same as those described in connection with operations 501 of FIG. 5A. Based on the determination of operations 521, mobile WSD 100 generates and sends a probe request 522. Probe request 522 may be substantially similar to probe request 502 of FIG. 5A. Probe request 522 is received by AP 103 and by AP 102.

AP 103 analyzes probe request 522 and extracts the AP response criteria contained therein (operations 523). AP 103 then determines that it cannot satisfy those extracted AP response criteria. Unlike the embodiment of FIG. 5A, however, AP 103 generates and sends a probe response 524. Probe response 524 (which may also be in the form of frame 300 and include information as described in connection with FIGS. 3 and 4) may include AP response parameters indicating AP response criteria met by AP 103 and other criteria not met by AP 103, but further including alternate parameters (e.g., a spectrum mask that does not meet the AP response criteria but that is supported by AP 103). Probe request 522 is also received and analyzed by AP 102 (operations 525). As part of that analysis, AP 102 extracts the AP response criteria in probe request 522 and determines that AP 102 can satisfy all of those criteria. As a result of determining that it does satisfy all of the AP response criteria contained in probe request 522, AP 102 generates and sends a probe response 526 to WSD 100 in response to probe request 522. Probe response 526 may be similar to probe response 505 of FIG. 5A. Subsequently, after evaluating probe responses 524 and 526 (operations 527), mobile WSD 100 selects AP 102, and mobile WSD 100 and AP 102 exchange further communications (operations 528) so that mobile WSD 100 is enabled by AP 102 and able to communicate with the WLAN of AP 102 and/or with additional networks (e.g., Internet 109) via the WLAN of AP 102. Communications 528 may be similar to those of communications 506 in FIG. 5A. In still other embodiments, the determination of operations 527 may result in WSD 100 selecting AP 103 (e.g., after WSD reconfigures its transmission profile to conform to a spectrum mask accepted by AP 103) and exchanging communications 528 with AP 103 instead of AP 102.

In some embodiments, AP response criteria such as are described in connection with FIG. 2 may be transmitted from a scanning WSD to a scanned AP using a modified generic advertisement service (GAS) initial request frame. AP response parameters can be transmitted from a scanned AP to a scanning WSD using a modified GAS initial response frame or using a modified GAS comeback response frame. GAS frames, without modifications to include AP response criteria or AP response parameters as described herein, are described in the aforementioned IEEE 802.11-2012 standard and/or other IEEE standards. In some embodiments, a scanning WSD may transmit a probe request or modified GAS initial request frame using any (or all) channels available to the scanning WSD (e.g., channels from a list of available channels provided by the AP with whose BSS the scanning WSD is currently associated).

In some embodiments, a communication service provider may manage multiple APs. Those multiple APs may be connected to an RLSS (e.g., RLSS 108 of FIG. 1) or otherwise in communication with a control element. Instead of including a list of WSDBs or GDB service providers in AP response criteria and/or AP response parameters (or in addition to such a list), the AP response criteria and/or AP response parameters could indicate a provider of a location-dependent communication parameter database by including data identifying the communication service provider.

As previously indicated, a WSD enabled by a particular AP receives a unicast CVS (contact verification signal) from that AP in order to continue using a channel and other enablement parameters authorized by an enabling STA. In existing systems, an AP transmits a CVS to all dependent WSDs with the same periodicity. This essentially assumes that all dependent WSDs maintain static locations. The time between CVSs can be relatively long. In the FCC regulatory scheme, for example, that time can be as much as 60 seconds. If a dependent WSD is not statically located and is moving at a relatively fast speed, the WSD could be out of range before it can receive an expected CVS. Because a dependent WSD may be out of range from the current AP sending the CVS frame before it can join a BSS of a different AP, such delay in CVS can cause problems. For example, the WSD may experience session or service discontinuity. Moreover, CVSs in existing systems do not include any indication of the relative distance of the AP from the dependent WSD.

In some embodiments, a dependent WSD can request that an AP send a CVS immediately and without waiting for the next scheduled CVS transmission. This may allow a moving dependent WSD to determine if an enabling AP is still in range. Such a request may also permit an AP to transmit future CVSs at shorter intervals.

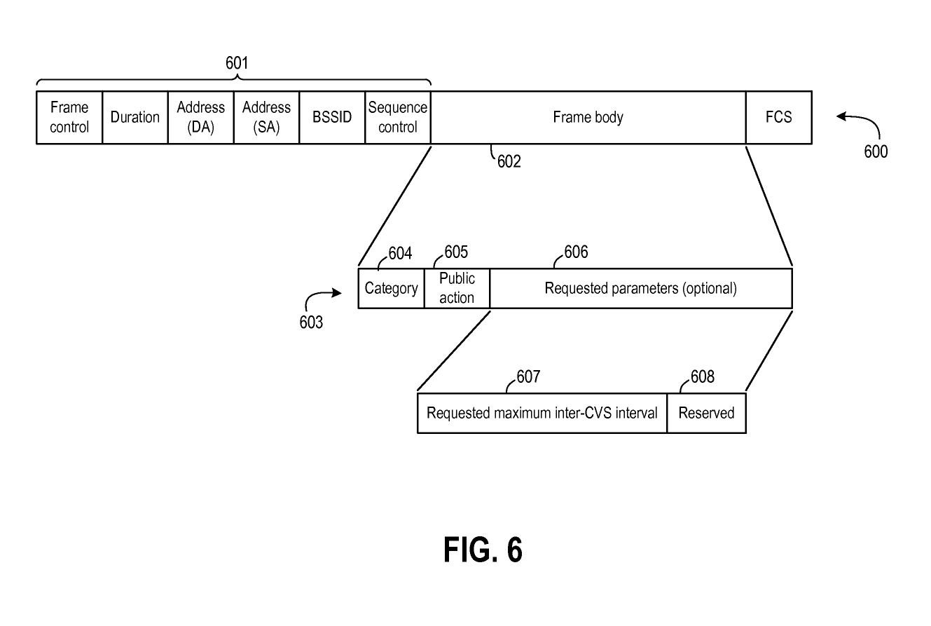

FIG. 6 is a diagram showing data carried by a CVS request frame 600 according to at least some embodiments. A dependent WSD (e.g., WSD 100) could transmit frame 600 to an AP in the current BSS of the WSD to request an immediate CVS (e.g., to confirm the WSD is still in range of the AP) and, optionally, to request that the AP begin transmitting CVSs to the WSD with a maximum interval between CVSs (maximum “inter-CVS interval”) that is shorter than a maximum inter-CVS interval currently being used. In some embodiments, frame 600 could be an action frame in accordance with IEEE 802.11-2012 and/or other IEEE standards. A dependent WSD may transmit frame 600 at any time the WSD determines that a CVS is needed. As but one example, a WSD may be configured to request a CVS (prior to the next scheduled CVS) if the WSD determines that it is moving at a speed above a particular threshold. A WSD with a GPS or other geo-location capability could determine its speed using such geo-location capability.

CVS request frame 600 may include a MAC header 601. MAC header 601 may also be a conventional 802.11 MAC header, and may include a two byte frame control field, a two byte duration field, a six byte field for destination address (DA) (e.g., a DA for the enabling AP of the BSS of which the transmitting WSD is a member), a six byte field for a source address (SA) (e.g., an SA of the transmitting WSD), a six byte field for a BSS identifier (BSSID) (e.g., the BSSID of the BSS of which transmitting WSD is a member) and a 2 byte sequence control field. Frame 600 may further include a frame body 602, of between zero and 2312 bytes, as well as a four byte frame check sequence (FCS).

Frame body 602 may contain a CVS request data element 603. Data element 603 may include a category field 604, a public action field 605 and a requested parameters field 606. Category field 604 may contain data indicating that frame 600 is a public action type. Public action field 605 may contain data indicating a specific type of public action being requested. In some embodiments, a new public action type corresponding to a CVS request may be defined. Requested parameters field 606 may contain a field 607 that indicates a request for the enabling AP to begin transmitting CVSs to the requesting WSD using a maximum interval between CVSs that is designated in field 607. Field 608 of requested parameters field 606 may be reserved.

In some embodiments, requested parameters field 606 may be optional. For example, an AP may be configured to recognize any CVS request frame as a request to immediately transmit a CVS to the WSD from which the CVS request frame was received. The AP may be further configured to analyze the CVS request frame and determine if a requested parameters field is present. If a requested parameters field is present, the AP may be further configured to analyze that field, determine the requested maximum inter-CVS interval, and either begin transmitting CVSs according to the requested maximum interval (i.e., at the requested interval or more rapidly) or to inform the requesting WSD that the request cannot be fulfilled.

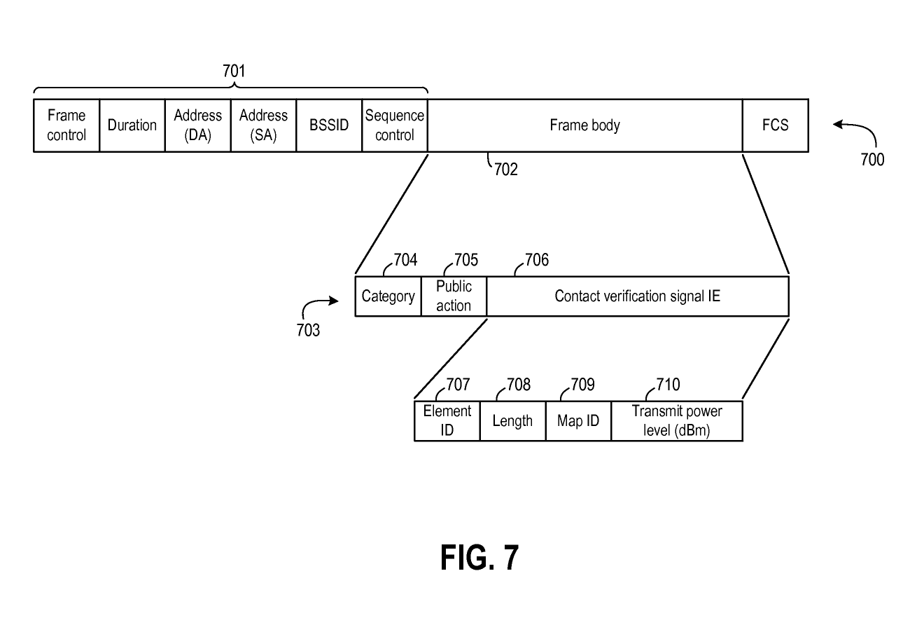

FIG. 7 is a diagram showing data carried by a modified CVS frame 700 according to some embodiments. An AP receiving a CVS request frame 600 could respond by transmitting CVS frame 700. Except as described below, and except for the fact that frame 700 (and subsequent similar frames) can be transmitted according to a shorter maximum inter-CVS interval in response to a CVS request, CVS frame 700 could otherwise be similar to existing CVS frames as defined by IEEE 802.11-2012 and/or other IEEE standards. In particular, frame 700 includes a MAC header 701 having a two byte frame control field, a two byte duration field, a six byte field for destination address (DA) (e.g., a DA for the WSD from which the CVS request was received), a six byte field for a source address (SA) (e.g., an SA of the transmitting AP), a six byte field for a BSS identifier (BSSID) and a 2 byte sequence control field. Frame 700 may further include a frame body 702, of between zero and 2312 bytes, as well as a four byte frame check sequence (FCS).

Frame body 702 includes a CVS data element 703. Similar to conventional CVS data elements, element 703 may include a category field 704 containing data indicating that frame 700 is a public action frame, a public action field 705 containing data indicating a specific type of public action (i.e., a CVS) and CVS data element 706. Element 706 may contain an Element ID field 707, a Length field 708 and a Map ID field 709 similar to those of conventional CVS frames. Unlike conventional CVS frames, however, element 706 includes a field 710 that contains data indicating transmit power (in dBm) used by the AP to send CVS frame 700.

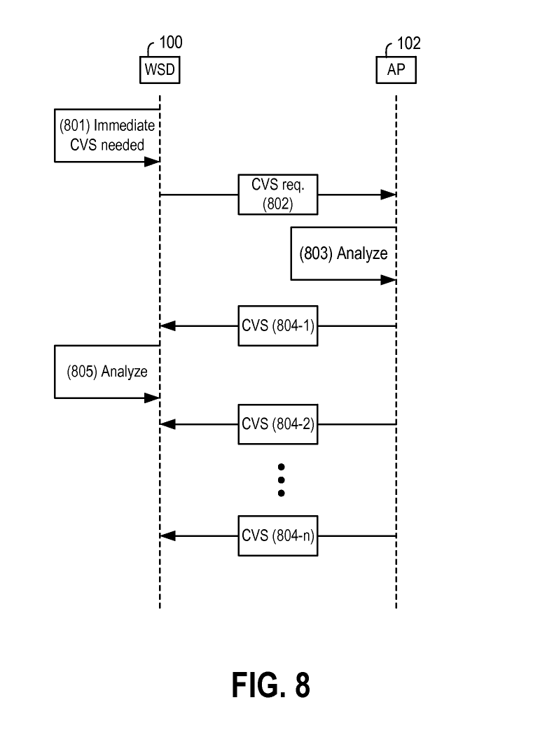

FIG. 8 is a diagram showing operations of, and communications between, between mobile WSD 100 and AP 102 of FIG. 1 according to at least some embodiments. The operations and communications shown in FIG. 8 may in some cases take place after communications and operations as shown in FIG. 5A or 5B. Operations and communications similar to those shown in FIG. 8, but involving WSD 100 and AP 101, can also occur prior to communications and operations as shown in FIG. 5A or 5B.

As indicated by operations 801, WSD 100 determines that an immediate CVS is needed. As indicated above, this determination can be the result of WSD 100 determining that it is moving at a speed above a predefined threshold. In the present example, WSD 100 also determines that it wishes to receive future CVSs from AP 102 at a shorter maximum inter-CVS interval. As a result of the determinations of operations 801, WSD 100 sends a CVS request 802 to AP 102. CVS request 802 may be in the form of frame 600 (FIG. 6) and may include information as described above in connection with frame 600. CVS request 802 is received by AP 102. AP 102 analyzes CVS request 802 and identifies the communication as a CVS request (operations 803). AP 102 also determines that a requested parameters field is present and extracts the requested maximum inter-CVS interval contained therein.

As a result of the determinations of operations 803, AP 102 transmits an immediate CVS 804-1 addressed to WSD 100. Also as a result of those determinations, AP 102 transmits subsequent CVSs 804-2, etc., addressed to WSD 100 according to the maximum inter-CVS interval requested by WSD 100 in CVE request 802. The CVSs 804 may be in the form of frame 700 (FIG. 7) and may include information as described above in connection with frame 700.

Upon receiving one of frames 804, and as indicated by operations 805, WSD 100 analyzes the received CVS 804 and extracts data indicating the transmit power used by AP 102 when transmitting that CVS. WSD 100 may use that data to estimate the relative path loss and/or distance from AP 102. WSD 100 may then use that estimation to determine, e.g., when it should begin searching for a new AP and/or begin an FT process to join a new BSS. This may allow WSD 100 to immediately determine its distance from AP 102 (i.e., by sending CVS request 802) instead of waiting for the next Beacon frame from AP 102.

In some embodiments, an AP may use specific transmit powers for CVSs directed to individual WSDs. These CVS transmit powers may be different from a transmit power used by the AP to send beacon frames. Beacon frames, which are described by IEEE 802.11-2012 and/or other IEEE standards, are distinct from CVS frames and typically are broadcast by the AP and not directed to individual APs. This may allow the AP to use CVSs to control the intended areas of specific WSDs.

In some embodiments, an AP may determine that it cannot (or will not) provide CVSs to a WSD at a compressed inter-CVS interval requested by a WSD. In some such embodiments, the AP might still send an immediate CVS to the requesting WSD, but may further indicate to the requesting WSD (e.g., in another added field of a CVS frame) that future CVSs will not be sent according to the requested maximum inter-CVS interval. In certain embodiments, the AP might further indicate that future CVSs will be sent using a compressed inter-CVS interval that is a longer than that requested by the WSD.

Returning to FIG. 1, when a client mobile WSD such as mobile WSD 100 is able to determine its location and provide that information to its serving AP (e.g., to AP 101 or 102), and at least in the Ofcom regulatory scheme, a serving AP may be required to respond with a new set of communication parameters applicable to that mobile WSD location. The serving AP may need to perform a new database query (e.g., to WSDB 110) on behalf of the relocated mobile WSD for each of such requests. The mobility of such client STAs within a BSS can cause substantial protocol load for the master device. In particular, the serving AP may need to consult the database and obtain the available channel and other parameters (e.g., permitted power levels) whenever the mobile WSD moves by certain distance. Under current Ofcom rules, that distance is 50 meters. Moreover, each database consultation requires some amount of time to complete. If the database is consulted every time an AP receives a request from a mobile WSD that has moved more than 50 meters, there may be substantial breaks in service due to the delays in the database consultations. This may be aggravated by the bursty nature of requests coming from multiple clients at any time. It would be useful if an AP or other element could control mobility scenarios of AP client stations so that the protocol load, protocol delays and the mobility behavior within the BSS of the AP can be managed more efficiently.

In some embodiments, a serving AP or other master WSD may employ a mobility manager to control mobility-related operations applicable to each mobile WSD or other client that is able to determine its own location. The mobility manager may be, e.g., an instance of an executing software program associated with a specific device, a client-specific program thread, or implemented in some other manner. The mobility manager may reside on an AP. The mobility manager may alternatively or also reside in an RLSS (e.g., RLSS 108) connected to a serving AP. Upon receiving a GAS message with a CAQ element from a client mobile WSD, the serving AP may forward the GAS message and CAQ element to the RLSS. The RLSS may then respond to the serving AP with data (e.g., channel list, power settings) that the AP then forwards to the client mobile WSD. The RLSS may query a WSDB (e.g., WSDB 110) in the background. The mobility manager may schedule such queries in order to balance or reduce load on the communication channels between the AP and the WSDB.

For example, a mobility manager may execute one or more routines to monitor the movement of a mobile WSD within the region of its serving AP (e.g., coverage area 105 or coverage area 106), collect information about the mobility, direction and/or speed of the mobile WSD, and/or predict the likely regions to which the mobile WSD may travel. The mobility manager may predict such regions by determining the average speed of the mobile WSD based on recent reported locations and may extend a contour area around last-reported position of the mobile WSD. A mobility manager may also or alternatively employ a prediction algorithm that utilizes weighted scaling based on any known direction of mobility. For example, the prediction may include more areas in a likely direction of travel (e.g., based on the locations of buildings or other known obstructions in a potential path) compared to areas in other directions. As another example, a mobile WSD may include information about its predicted motion in communications to the serving AP (e.g., an information element providing the bearing and/or speed of the mobile WSD). After predicting likely regions into which the mobile WSD may travel, the mobility manager can perform WSDB queries for multiple such locations beforehand and in the background. In this way, the mobility manager can utilize load balancing for its protocol messaging with the WSDB for multiple clients and have more control over when to perform the necessary database queries.

In some embodiments, an AP may activate a mobility manager for a mobile WSD as part of the process of granting enablement to that WSD. For example, a GDC enablement request initially transmitted by the mobile WSD to the AP may identify the WSD as a mobile or portable device. As a result of that identification of the mobile WSD as mobile or portable, the may AP activate (or cause an RLSS or other element to activate) a mobility manager for that mobile WSD.

When a client mobile WSD determines that it has moved by a certain distance from a previous location (e.g., a location previously reported to its serving AP) and that it must report its new location to its serving AP, the mobile WSD may send a CAQ request with the new location information. In some cases, the mobile WSD may include additional locations in the CAQ request based on its predicted mobility region. For example, the mobile WSD may utilize its estimated speed and direction or additional information on its route (e.g., data from a navigation application that may also be executing on the WSD) to predict its future location. The mobile WSD may also or alternatively include location information such as a discrete number of possible future locations. The mobile WSD may also or alternatively include location information in the form of its current location and a projected future location, with the projected future location including uncertainty fields to indicate a larger area or volume within which the projected future location might move.

When responding to a CAQ request from a client, an AP may consult the mobility manager. In some cases, the mobility manager may have been previously able to query the WSDB for data regarding predicted future locations of the mobile WSD. For example, the WSD may have provided movement and/or future location information, or data from which a future location could be estimated, during the enablement process. As another example, the just-received CAQ request may be a second or subsequent CAQ request from the mobile WSD. If the mobility manager was previously able to query the WSDB for data regarding predicted future locations of the mobile WSD, if that query yielded data (e.g., channel lists, transmit power, other communication parameters) for the WSD location reported in the just-received CAQ request, and if that data has not expired and is otherwise still valid, the mobility manager provides that data from local memory (e.g., of RLSS 108) without need of a further WSDB query. The AP may then include that data in a CAQ response transmitted to the mobile WSD. In this way, the mobile WSD is able to receive its response quickly and without delay associated with a WSDB consultation. If the mobility manager was not previously able to query the WSDB for data regarding future locations, or if any previous queries provided information which has expired or which does not apply to the current mobile WSD location (e.g., if the mobile WSD moved to a location outside of the area or volume of expected movement), the mobility manager can query the WSDB in a conventional manner.

Regardless of whether the mobility manager was able to provide CAQ response data based on previous queries, the information included in the just-received CAQ request, together with previously-provided location information (if any), can be used to predict future locations of the mobile WSD. The mobility manager may then query the WSDB in the background regarding predicted future locations.

In some embodiments, a mobility manager may cause a serving AP to request that a mobile WSD report its location and/or provide data regarding possible future locations in advance of a CAQ request from the WSD. In some additional embodiments, a mobility manager may obtain an available channel list valid for a bounded region by providing device characteristics of a mobile WSD, together with location information to represent a bounded region, to the WSDB. After the mobility manager receives that channel list from the WSDB and stores it locally, the AP may use that locally stored information to respond to new channel queries from the mobile WSD (e.g., CAQ requests) with the channel list and associated parameters as long as the mobile device reported location remains within the bounded region and the information provided by the WSDB does not expire or otherwise become invalid.

A mobility manager may be able to identify which WSDs served by an AP are capable determining their own locations, as well as which WSDs lack such capability. The ability of a WSD to determine its own location may change dynamically. For example, the ability of a device to determine location vary based on device position, e.g., when the device moves indoors and a satellite signal is lost. As another example, the ability of a device to determine location may change based on confidence level and accuracy of the obtained geo-location information (e.g., GPS signals) indicating a location calculation is not sufficiently accurate. As a further example, a fixed master WSD under the Ofcom regulatory scheme is required to indicate if its antenna position is indoors or outdoors. A mobile WSD receiving a beacon from such a master WSD that is not the serving AP of the mobile WSD may imply that the mobile WSD has moved indoors.

A mobile WSD may provide information about its location-determination capacity in the device class field carried with CAQ and GDC enablement frames. Alternately, such information could be added as one or more new fields in an existing extended capabilities element, or as part of other existing fields used to communicate device characteristics of the mobile WSD.

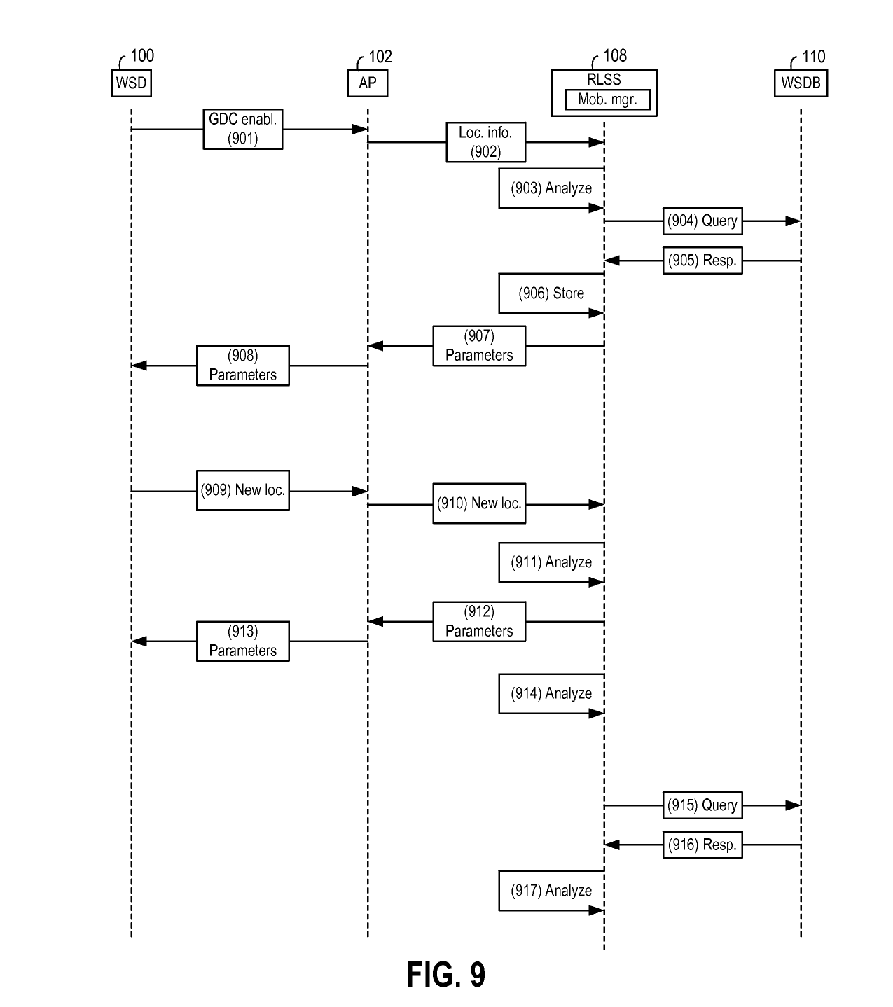

FIG. 9 is a diagram showing mobility management communications among, and operations of, mobile WSD 10, AP 102, RLSS 108 and WSDB 110 of FIG. 1 according to at least some embodiments. The operations and communications shown in FIG. 9 may in some cases take place after communications and operations as shown in FIG. 5A or 5B. Operations and communications similar to those shown in FIG. 9, but involving and AP 101 instead of AP 102, might also occur prior to communications and operations as shown in FIG. 5A or 5B.

As indicated by communication 901, mobile WSD 100 sends an initial GDC enablement request to AP 102. The initial GDC enablement request includes data regarding the current position of mobile WSD, as well as data regarding possible future positions of mobile WSD 100. AP 102 forwards this current and future location data to a mobility manager executing on RLSS 108 (communication 902). As a result of the received information, and as indicated by operations 903, the mobility manager performs several operations. The mobility manager first starts a separate program thread or instantiates a new program instance that corresponds to mobile WSD 100. The mobility manager may then perform further operations relating to mobile WSD 100 in that separate thread or instance. Also in operations 903, the mobility manager analyzes the location data from mobile WSD 100 and predicts a region of coverage area 106 within which mobile WSD 100 is likely to move.

The mobility manager then queries WSDB 110 for channels and other communication parameters applicable to mobile WSD 100 in its current location or elsewhere within the region predicted by the mobility manager in operations 903 (communication 904). WSDB 110 subsequently responds with those channels and other parameters (communication 905). The mobility manager locally stores the data received from WSDB 110 (operation 906). The mobility manager then provides some or all of that data to AP 102 (communications 907). AP 102 then completes the enablement process for mobile WSD 100 and provides information, received from WSDB in communication 905, that includes permitted channels and other parameters applicable to the current location of mobile WSD 100 (communications 908).

At a subsequent time mobile WSD 100 sends a CAQ request or other communication to AP 102 indicating that mobile WSD 100 has moved to a new location within coverage area 106 (communication 909). For example, WSD 100 may send communication 909 at time t2 upon moving to the location shown in FIG. 1. Communication 909 may also include additional information for estimation of future locations of mobile WSD 100. AP 102 forwards location information received in communication 909 to the mobility manager (communication 910). In operations 911, the mobility manager accesses data previously stored in operations 906 and determines that the new location of mobile WSD 108 is within the previously predicted region of WSD 100 movement. As part of operations 911, the mobility manager also determines that a channel list and/or other parameters applicable to the new locations are locally stored and that such parameters are still valid. The mobility manager sends the parameters for the new WSD 100 location to AP 102 in communication 912. AP 102 provides those parameters to WSD 100 in a CAQ response or other type of communication (communication 913).

In operations 914, the mobility manager analyzes the location data from mobile WSD 100 received in communication 910 and again predicts a region of coverage area 106 within which mobile WSD 100 is likely to move. Without waiting for a new CAQ request from WSD 100, the mobility manager then queries WSDB 110 for parameters applicable to the new predicted region (communication 914). Communication 915 may not immediately follow operations 914. For example, the mobility manager may defer sending communication 915 until there is a reduced amount of communication traffic between AP 102 and WSDB 110 or between RLSS 108 and WSDB 110. WSDB 110 responds to the mobility manager query in communication 916. The mobility manager stores parameters from communication 916, in operations 917, in anticipation of further CAQ requests from WSD 100.

In the embodiment of FIG. 9, the mobility manager is executed by RLSS 108. As previously indicated, a mobility manager in some embodiments may be executed by an AP. In some such embodiments, operations similar to operations 903, 906, 911, 914 and 917, as well as communications similar to communications 904, 905, 915 and 916, may be performed by the AP instead of an RLSS.

Exemplary Hardware and/or Software

Various types of computers can be used to implement a WSD (including APs and mobile WSDs), an RLSS, a WSDB or other components performing communications and other operations according to various embodiments. Exemplary computers include, without limitation, smart cards, media devices, personal computers, engineering workstations, PCs, Macintoshes, PDAs, portable computers, computerized watches, wired and wireless terminals, telephones, communication devices, servers, network access points, network multicast points, network devices, set-top boxes, personal video recorders (PVRs), game consoles, portable game devices, portable audio devices, portable media devices, portable video devices, televisions, digital cameras, digital camcorders, Global Positioning System (GPS) receivers and wireless personal servers.

A computer may execute one or more operating systems. Exemplary operating systems include Windows Phone (e.g., Windows Phone 7), Windows (e.g., Windows 8, Windows 7, or Windows Vista), Windows Server (e.g., Windows Server 8, Windows server 2008, or Windows Server 2003), Maemo, Symbian OS, WebOS, Linux, OS X, and iOS. A computer may also support one or more of the S60 Platform, the .NET Framework, Java, and Cocoa. A computer may also include one or more processors operatively connected to one or more memory or storage units, wherein the memory or storage optionally contains machine-readable instructions and/or other data, and the processor or processors execute the machine-readable instructions and/or manipulate the data.

FIG. 10 shows an exemplary computer 1000 according to some embodiments. Computer 100 includes a system bus 1001 which operatively connects one or more processors 1002, random access memory 1003, read-only memory 1004, input output (I/O) interfaces 1005 and 1006, storage interface 1007 and display interface 1009. Storage interface 1007 in turn connects to a mass storage 1008. Each of I/O interfaces 1005 and 1006 may be one or more of an Ethernet, IEEE 1394, IEEE 1394b, IEEE 802.11-2012, IEEE 802.11a, 802.11af, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16m, IEEE 802.16x, IEEE 802.20, IEEE 802.22, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Long Term Evolution (LTE), Global System for Mobile Communications (GSM), Code Division Multiple Access 2000 (CDMA2000), DVB-H (Digital Video Broadcasting: Handhelds), HDMI (High-Definition Multimedia Interface), Thunderbolt, IrDA (Infrared Data Association) or other type of interface. Interface 1005 may include a transceiver 1021, an antenna 1022 and other components for communication in the TVWS or in other portions of the radio spectrum. Interface 1006 and/or other interfaces (not shown) may similarly include a transceiver, an antenna and other components for communication in the TVWS or in other portions of the radio spectrum, and/or hardware and other components for communication over wired or other types of communication media.

Mass storage 1008 may be a hard drive, flash memory or other type of non-volatile storage device. Processor(s) 1002 may be, e.g., an ARM-based processor such as a Qualcomm Snapdragon or an x86-based processor such as an Intel Atom or Intel Core. Computer 1000 may also include a touch screen (not shown) and physical keyboard (also not shown). A mouse or keypad may alternately or additionally be employed. A physical keyboard might optionally be eliminated. Computer 1000 may optionally include or be attached to one or more image capture devices.

Computer 1000 may optionally include or be attached to one or more card readers, DVD drives, floppy disk drives, hard drives, memory cards, or ROM devices whereby media machine-readable instructions, including program code or other instructions for performing operations and communications described herein, is optionally inserted for the purpose of loading instructions onto the computer. Further, such machine-readable instructions may optionally be loaded onto the computer via one or more of I/O interfaces 1005 and 1006.

Computers may be configured to perform operations and communications described herein using one or more software modules. Such modules may be programmed using one or more languages. Exemplary languages include, without limitation, C#, C, C++, Objective C, Java, Perl, and Python.

Any indicated division of operations among particular software modules or devices is for purposes of illustration, and alternate divisions of operation are possible. Accordingly, any operations indicated to be performed by one software module are according to an alternative implementation instead performed by a plurality of software modules. Similarly, any operations indicated to be performed by a plurality of modules may according to an alternative implementation be performed by a single module.

Further, operations indicated to be performed by a particular computer such as a particular WSD may according to an alternative implementation instead performed by a plurality of computers such as by a plurality of WSDs. Moreover, peer-to-peer, cloud, and/or grid computing techniques are optionally employed. Additionally, implementations may include remote communication among software modules. Exemplary remote communication techniques include Simple Object Access Protocol (SOAP), Java Messaging Service (JMS), Remote Method Invocation (RMI), Remote Procedure Call (RPC), sockets, and pipes.

Operations discussed herein may be implemented via hardware that contains hard-coded instructions (e.g., logic gates and other structures) configured to perform operations and communications described herein. Examples of such implementation via hardware include the use of one or more of integrated circuits, specialized hardware, chips, chipsets, application-specific integrated circuits (ASICs), and field-programmable gate arrays (FPGAs). Machine-executable instructions can include hard-coded instructions.

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. For example, one of ordinary skill in the art will appreciate that operations and communications illustrated in the illustrative figures may be performed in other than the recited order, and that one or more illustrated operations and communications may be optional in one or more embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention, including all permutations of the independent and dependent claims set forth herein.

1. A method comprising:
transmitting a request communication from a mobile device to one or more candidate wireless network access points, wherein the request communication comprises one or more response criteria for the one or more candidate wireless network access points and wherein the response criteria include data indicating a location-dependent communication parameter and/or data corresponding to at least one of a location-dependent communication parameter database or a provider of a location-dependent communication parameter database;
receiving a response communication at the mobile device from a responding access point in response to the transmitted request communication; and
based on the received response communication, exchanging further communications between the mobile device and the responding access point.

2. The method of claim 1, wherein the location-dependent communication parameter database comprises a TV white space database, the mobile device is a white space device, and the further communications are enabling communications.

3. The method of claim 2, wherein the location-dependent communication parameter comprises a spectrum mask of the mobile device.

4. The method of claim 2, wherein the location-dependent communication parameter comprises one or more channels and a minimum transmit power level.

5. The method of claim 2, wherein the location-dependent communication parameter comprises at least one of a type of access point device and a mobility domain identifier.

6. The method of claim 2, further comprising:
determining, by the mobile device, location information regarding a current location of the mobile device; and
transmitting the location information to the responding access point.

7. The method of claim 6, wherein the location information includes data indicating a predicted future position of the mobile device.

8. The method of claim 2, further comprising:
determining, by the mobile device and after exchanging the enabling communications, that a position of the mobile device has changed; and
transmitting from the mobile device to the responding access point a request for at least one of transmission of a verification signal and transmission of future verification signals using a specified maximum time between verification signals.

9. The method of claim 9, further comprising:
extracting, by the mobile device from a received verification signal, data indicating a transmit power used to transmit the received verification signal; and
determining, by the mobile device and based on the extracted data, that the mobile device should transition to communications with a different access point.

10. One or more non-transitory machine-readable media storing machine-executable instructions that, when executed by a device, cause the device to at least:
transmit a request communication from the device to one or more candidate wireless network access points, wherein the request communication comprises one or more response criteria for the one or more candidate wireless network access points and wherein the response criteria include data indicating a location-dependent communication parameter and/or data corresponding to at least one of a location-dependent communication parameter database or a provider of a location-dependent communication parameter database;
receive a response communication at the device from a responding access point in response to the transmitted request communication; and
based on the received response communication, exchange further communications between the device and the responding access point.

11. An apparatus comprising:
at least one processor; and
at least one memory, at least one of the at least one memory and at least one processor storing machine-executable instructions that cause the apparatus, upon execution of the instructions, to at least
transmit a request communication to one or more candidate wireless network access points, wherein the request communication comprises one or more response criteria for the one or more candidate wireless network access points and wherein the response criteria include data indicating a location-dependent communication parameter and/or data corresponding to at least one of a location-dependent communication parameter database or a provider of a location-dependent communication parameter database,
receiving a response communication from a responding access point in response to the transmitted request communication, and
based on the received response communication, exchange further communications with the responding access point.

12. The apparatus of claim 11, wherein the location-dependent communication parameter database comprises a TV white space database, the apparatus is a white space device, and the further communications are enabling communications.

13. The apparatus of claim 12, wherein the location-dependent communication parameter comprises a spectrum mask of the apparatus.

14. The apparatus of claim 12, wherein the location-dependent communication parameter comprises one or more channels and a minimum transmit power level.

15. The apparatus of claim 12, wherein the location-dependent communication parameter comprises at least one of a type of access point device and a mobility domain identifier.

16. The apparatus of claim 12, wherein the machine-executable instructions cause the apparatus, upon execution of the instructions, to at least
determine location information regarding a current location of the apparatus, and
transmit the location information to the responding access point.

17. The apparatus of claim 16, wherein the location information includes data indicating a predicted future position of the apparatus.

18. The apparatus of claim 12, wherein the machine-executable instructions cause the apparatus, upon execution of the instructions, to at least
determine, after exchanging the enabling communications, that a position of the apparatus has changed, and
transmit to the responding access point a request for at least one of transmission of a verification signal and transmission of future verification signals using a specified maximum time between verification signals.

19. The apparatus of claim 18, wherein the machine-executable instructions cause the apparatus, upon execution of the instructions, to at least
extract, from a received verification signal, data indicating a transmit power used to transmit the received verification signal, and
determine, and based on the extracted data, that the apparatus should transition to communications with a different access point.

20. A method comprising:
receiving a request communication from a mobile device at a wireless network access point, the request communication comprising access point response criteria, the access point response criteria including data indicating a location-dependent communication parameter and data corresponding to at least one of a location-dependent communication parameter database or a provider of a location-dependent communication parameter database;
determining that the one or more access point response criteria are satisfied with regard to the access point; and
based on determining that the one or more access point response criteria are satisfied with regard to the access point, transmitting a response communication to the mobile device.

21. The method of claim 20, wherein the location-dependent communication parameter database comprises a TV white space database, the access point is a white space device, and the further communications are enabling communications.

22. The method of claim 21, wherein the location-dependent communication parameter comprises at least one of a spectrum mask of the mobile device, one or more channels, a minimum transmit power level, a type of access point device and a mobility domain identifier.

23. The method of claim 21, further comprising:
receiving, from the mobile device, a request for transmission of future verification signals using a specified maximum time between verification signals; and
in response to the received request, transmitting verification signals using the specified maximum time between verification signals.

24. The method of claim 20, wherein the access point is part of a system that includes a computer configured to execute a mobility manager, and further comprising:
predicting one or more possible future locations of the mobile device;
querying the location-dependent communication parameter database for communication parameters associated with the one or more possible future locations;
receiving and storing data, in response to the querying, comprising the communication parameters associated with the one or more possible future locations;
receiving a later communication from the mobile device after the receiving and storing, the later communication including data indicating a new location of the mobile device;
retrieving, from the stored data and in response to the later communication, data indicating communication parameters associated with the new location; and
transmitting the retrieved data to the mobile device.

25. The method of claim 24, wherein the computer is separate from the access point and comprises a registered location secure server.

26. The method of claim 24, wherein the computer is also the access point.

27. One or more non-transitory machine-readable media storing machine-executable instructions that, when executed by a device, cause the device to at least:
receive a request communication from a mobile device, the request communication comprising access point response criteria, the access point response criteria including data indicating a location-dependent communication parameter and data corresponding to at least one of a location-dependent communication parameter database or a provider of a location-dependent communication parameter database;
determine that the one or more access point response criteria are satisfied with regard to the device; and
based on determining that the one or more access point response criteria are satisfied with regard to the device, transmit a response communication to the mobile device.

28. An apparatus comprising:
at least one processor; and
at least one memory, at least one of the at least one memory and at least one processor storing machine-executable instructions that cause the apparatus, upon execution of the instructions, to at least
receive a request communication from a mobile device, the request communication comprising access point response criteria, the access point response criteria including data indicating a location-dependent communication parameter and data corresponding to at least one of a location-dependent communication parameter database or a provider of a location-dependent communication parameter database,
determine that the one or more access point response criteria are satisfied with regard to the apparatus, and
based on determining that the one or more access point response criteria are satisfied with regard to the apparatus, transmit a response communication to the mobile device.

29. The apparatus of claim 28, wherein the location-dependent communication parameter database comprises a TV white space database, the access point is a white space device, and the further communications are enabling communications.

30. The apparatus of claim 29, wherein the location-dependent communication parameter comprises at least one of a spectrum mask of the mobile device, one or more channels, a minimum transmit power level, a type of access point device and a mobility domain identifier.

31. The apparatus of claim 29, wherein the machine-executable instructions cause the apparatus, upon execution of the instructions, to at least
receive, from the mobile device, a request for transmission of future verification signals using a specified maximum time between verification signals, and
in response to the received request, transmit verification signals using the specified maximum time between verification signals.

32. The apparatus of claim 28, wherein the apparatus is part of a system that comprises a second apparatus, the second apparatus comprising at least one processor and at least one memory, at least one of the at least one second apparatus memory and at least one second apparatus processor storing machine-executable instructions that cause the second apparatus, upon execution of the instructions, to at least
predict one or more possible future locations of the mobile device,
query the location-dependent communication parameter database for communication parameters associated with the one or more possible future locations,
receive and store data, in response to the querying, comprising the communication parameters associated with the one or more possible future locations,
retrieve, from the stored data, data indicating communication parameters associated with the new location, and
transmit the retrieved data.

33. The apparatus of claim 28, wherein the machine-executable instructions cause the apparatus, upon execution of the instructions, to at least
predict one or more possible future locations of the mobile device,
query the location-dependent communication parameter database for communication parameters associated with the one or more possible future locations,
receive and store data, in response to the querying, comprising the communication parameters associated with the one or more possible future locations,
receive a later communication from the mobile device after receiving and storing the data, the later communication including data indicating a new location of the mobile device,
retrieve, from the stored data and in response to the later communication, data indicating communication parameters associated with the new location, and
transmit the retrieved data to the mobile device.
